(19) United States
(12) Patent Application Publication
(10) Pub. No.: US 2026/0263899 A1
(43) Pub. Date: Sep. 10, 2026

(54) SKATEBOARD PIVOT TRUCK

(71) Applicant: Mark Groenenboom, Wyoming, MI (US)

(72) Inventor: Mark Groenenboom, Wyoming, MI (US)

(21) Appl. No.: 19/166,429

(22) PCT Filed: Apr. 3, 2023
(86) PCT No.: PCT/US23/17306

§ 371 Date: Sep. 17, 2025

(51) Int. Cl. A63C 17/01

(52) U.S. Cl. CPC A63C 17/012

(57) ABSTRACT

A skateboard truck having a pivot device that comprises a housing having a pivot hole and a housing contact surface, a pivot member supported by the pivot hole, a bushing having a periphery and positioned such that the pivot member is external to the bushing periphery, and a hanger supported by the pivot member and having a hanger contact surface in contact with the bushing periphery.

### BACKGROUND

The present technology is directed to skateboard truck apparatuses. Skateboarding has evolved into several different disciplines such as trick, to vert, to high speed downhill skating and as a form of exercise and transportation. At higher speeds, the skateboard operator typically travels longer distances and in a relatively straight line. While traveling in a straight line at high speeds the turning mechanism can become unstable. This device provides a means of turning while remaining stable at higher speeds.

Some of the embodiments include a skateboard with a truck similar to the cited prior art for steering, this truck will be referred to as a conventional truck, another truck which is constrained to two degrees of freedom. The conventional truck has an offset axis which allows the skateboard to turn. The latter truck restricts the axle compliance to vertical displacement of each wheel independently and rotationally about an axis perpendicular to this vertical displacement. The combination of this truck with the conventional truck mentioned above, uniquely allows for propulsion and stability at higher speeds.

### SUMMARY

According to some examples, the present technology is directed to a skateboard truck that allows pivoting about the direction of travel and vertical compliance. In other examples, the present technology is directed to a skateboard truck that allows pivoting about a set direction and vertical compliance.

Groenenboom U.S. Pat. No. 9,555,314 discloses a skateboard truck which provides for vertical and tilting compliance. This device has a tilting compliance that is essentially linear. As the compliance is deflected (as in a turn) the torsion resistance increases linearly. This compliance results in a softer response to the deflection at smaller compliance. The present device has been found to respond in a more precise manner. This may be caused by the geometry of the pivot used in the current device. Additionally, the device geometry can be modified such that different compliance profiles can be achieved. In some examples, the present device allows for a preload. This preload provides a tilt response force even at small tilt angles.

Groenenboom provides for vertical compliance. However, this vertical compliance is completely a function of the vertical force applied by the operator. The present device provides for preloading the vertical compliance. Preloading this compliance, allows operator solid support until a larger vertical force is applied to the wheels. This provides shock absorption with decreased vertical compliance.

Groenenboom discloses a device that provides tilt and vertical compliance. The current device provides for tilt compliance that is not restricted in a single direction. An axis of tilt compliance is determined by the geometry of the truck. This allows the operator additional control while turning.

Braden U.S. Pat. No. 9,010,777 discloses a skateboard truck with an elastic member which surrounds the kingpin. This elastic member provides for rotational movement around the kingpin. The device of Braden provides a cantilevered kingpin. This type of setup is subjected to high bending stress during use. This bending stress requires a larger and heavier kingpin to avoid failure. Failure of the kingpin can have safety concerns as the skateboard loses support of the wheels. In addition, Braden discloses a device which does not provide for vertical compliance.

Braden discloses a device where both extension and compression of an elastic member provide return to center and where the pivot axis of the hanger is through the elastic member. The current disclosure is a device with pivot axis external to the periphery of an elastic member. This permits the current device to use the compressive forces of that member to serve as both the centering force and, in certain embodiments, vertical and tilting compliance By pre-compressing the elastic member during assembly, the functions of centering, and vertical, and tilting compliance, may be preloaded to offer a higher force or torque during initial deflection. This also results in a higher suspension force during use.

Braden discloses a device that is unable to provide vertical compliance starting from the height position. A review of Braden teaches that vertical resistance is the operator's body weight until the board is forced upward (e.g., a bump in the ground). The current disclosure teaches a device which supports an operator before movement occurs. This is a result of preloading within the device.

Conventional trucks have a tendency to squeak during use. The present device significantly reduces this squeaking. Since squeaking is generally caused by sliding compliant interfaces between bushings, eliminating this type of contact results in less squeaking. Due to the geometry of the present device, sliding contacts are reduced.

Conventional trucks include a cantilevered bolt supported at an angle for allowing turning. This turning function is a result of bending the cantilevered bolt and overcoming friction between the hanger and bushings to slide the truck into a turning position. As a result of this conventional truck geometry, the cantilevered bolt (or kingpin), is highly stressed. Additionally, the truck overall has a sloppy feel as the kingpin and bushings must move (or slide) to accommodate turning. Adding additional constraints to conventional trucks to eliminate the sloppy feel adds cost and additional costly precision components. The current disclosure has the benefits of the precision components, but can be manufactured using industry standard processes to keep costs consistent with conventional trucks.

The present device addresses these and other shortcomings of the conventional truck. A pivot device that eliminates a cantilevered kingpin and sliding bushing is disclosed.

### BRIEF DESCRIPTION OF THE DRAWINGS

FIG. 1 depicts a top view of a skateboard with a compliant tilting truck.

FIG. 2 depicts a side view of a skateboard with a compliant tilting truck.

FIG. 3 depicts an expanded isometric view of a compliant tilting truck.

FIG. 4A depicts a side view of a pivot device attached to a hanger and wheels.

FIG. 4B depicts the cross-sectional view indicated in FIG. 4A.

FIG. 5A depicts an isometric view of a pivot device.

FIG. 5B depicts an expanded isometric view of a pivot device.

FIG. 6A depicts a front view of a compliant tilting truck in a tilted configuration.

FIG. 6B depicts a top view of a compliant tilting truck in a tilted configuration.

FIG. 6C depicts the partial cross-sectional view indicated in FIG. 6B.

FIG. 7A depicts a side view of a compliant tilting truck with a translated hanger.

FIG. 7B depicts a cross sectional view indicated in FIG. 7A.

FIG. 8 depicts a top view of a skateboard having a compliant tilting truck with pitch adjustment.

FIG. 9 depicts a side view of a skateboard having a compliant tilting truck with pitch adjustment.

FIG. 10A depicts a side view of a skateboard truck having a compliant tilting truck with pitch adjustment.

FIG. 10B depicts a side view of a skateboard truck with partial board having a compliant tilting truck with pivot adjustment with pivot device in a pitched configuration and tilted.

FIG. 10C depicts a top view of a skateboard having a compliant tilting truck with pitch adjustment with pivot device in a pitched configuration and tilted.

FIG. 10D depicts a front view of a skateboard having a compliant tilting truck with pitch adjustment with pivot device in a pivoted configuration and tilted.

FIG. 11A depicts an isometric view of a compliant tilting truck with pitch adjustment.

FIG. 11B depicts an expanded isometric view of a compliant tilting truck with pitch adjustment.

FIG. 11C depicts an expanded isometric view of a pivot device.

FIG. 12A depicts a side view of a pivot device, hanger and wheels in a translated configuration.

FIG. 12B depicts a section view indicated in FIG. 12A.

FIG. 13 depicts a front view of a compliant tilting truck with pitch adjustment in a tilted configuration.

FIG. 14A depicts a top view of a compliant tilting truck with pivot adjustment in a tilted configuration.

FIG. 14B depicts a cross section view indicated in FIG. 14A.

FIG. 15A depicts a top view of a compliant tilting truck with pitch adjustment with preload.

FIG. 15B depicts a section view of a compliant tilting truck with pitch adjustment with preload.

FIG. 15C depicts a detail view of a compliant tilting truck with pitch adjustment with preload indicated in FIG. 15B.

FIG. 16 depicts a top view of a skateboard with a compliant tilting truck with fixed pitch.

FIG. 17 depicts a side view of a skateboard with a compliant tilting truck with fixed pitch.

FIG. 18 depicts an isometric view of a compliant tilting truck with fixed pitch.

FIG. 19 depicts an expanded isometric view of a compliant tilting truck with fixed pitch.

FIG. 20A depicts a side view of a pivot device, truck mount, and a hanger in a translated configuration.

FIG. 20B depicts a pivot device, truck mount, and a hanger in a translated configuration indicated in view FIG. 20A.

FIG. 21A depicts a side view of a pivot device with hanger and wheels in a tilted configuration.

FIG. 21B depicts a cross section view indicated in FIG. 21A rotated to depict wheels in a horizontal orientation.

FIG. 22A depicts a side view of a pivot device with hanger and wheels in a preloaded configuration.

FIG. 22B depicts a cross section view indicated in FIG. 22A.

FIG. 23 depicts an isometric of a pivot device, with hanger and a fixed bushing.

FIG. 24 depicts an expanded isometric of a pivot device, with hanger and a fixed bushing.

FIG. 25 depicts a side view of a pivot device, with hanger and a fixed bushing.

FIG. 26 depicts a cross section view of a pivot device with hanger and fixed bushing.

FIG. 27 depicts a cross section view of a pivot device with hanger and fixed bushing in a translated configuration.

FIG. 28 depicts a cross section view of a pivot device with hanger and fixed bushing in a tilted configuration.

FIG. 29 depicts a cross section view of a pivot device with hanger and fixed bushing in a preloaded configuration.

FIG. 30 depicts a cross section view of a pivot device with a bell-shaped bushing.

FIG. 31 depicts a cross section view of a pivot device with a hex shaped bushing.

### DETAILED DESCRIPTION

Various aspects and examples of a skateboard truck, as well as related methods, are described below and illustrated in the associated drawings. Unless otherwise specified, a skateboard truck in accordance with the present teachings, and/or its various components, may contain at least one of the structures, components, functionalities, and/or variations described, illustrated, and/or incorporated herein in connections with the present teachings may be included in other similar devices and methods, include being interchangeable between disclosed examples. The following description of various examples is merely illustrative in nature and is in no way intended to limit the disclosure, its application, or uses. Additionally, the advantages provided by the examples and examples described below are illustrative in nature and not all examples and examples provide the same advantages or the same degree of advantages.

This Detailed Description includes the following section, which follows immediately below: (1) Definitions; (2) Overview; (3) Examples; (4) Advantages, Features, and Benefits; and (5) Conclusion.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional unrecited elements, or method steps. Terms such as “first,” “second,” and “third” are used to distinguish or identify various members of a group, or the like, and are not intended to show serial or numerical limitations.

The terms “inboard,” “outboard,” “forward,” “rearward,” and the like are intended to be understood in the context of a host vehicle on which systems described herein may be mounted or otherwise attached. For example, “outboard” may indicate a relative position that is laterally farther from the centerline of the vehicle, or a direction that is away from the vehicle centerline. Conversely, “inboard” may indicate a direction toward the centerline, or a relative position that is closer to the centerline. Similarly, “forward” means toward the front portion of the vehicle, and “rearward” means toward the rear of the vehicle. In the absence of a host vehicle, the same directional terms may be used as if the vehicle were present. For example, even when viewed in isolation, a device may have a “forward” edge, based on the fact that the device would be installed with the edge in question facing in the direction of the front portion of the host vehicle.

“Coupled” means connected, either permanently or releasably, whether directly or indirectly through intervening components.

“Resilient” describes a material or structure configured to respond to normal operation loads (e.g., when compressed) by deforming elastically and returning to an original shape or position when unloaded.

“Rigid” describes a material or structure configured to be stiff, non-deformable, or substantially lacking in flexibility under normal operation conditions.

“Elastic” describes a material or structure configured to spontaneously resume its former shape after being stretched or compressed.

“Providing,” in the context of a method, may include receiving, obtaining, purchasing, manufacturing, generating, processing, preprocessing, and/or the like, such that the object or material provided is in a state and configuration for other steps to be carried out.

“Operatively,” describes a connection between two devices or entities such that a function is provided from one entity to another. For example, a first entity may be operatively connected to a second entity for transferring force. In this example, a connection between first and second entity may be by gears, a belt, solder, or weld such that force (or torque) is transferred from first entity to second entity.

“Force,” and “torque,” in this disclosure includes positive and negative values. For instance, force provided to object one from object two means, object one pushes or pulls on object two and/or object two pushes or pulls on object one.

“Stress,” in this disclosure refers to force acting on any infinitesimal area located inside a load carrying member divided by the infinitesimal area. The direction of force relative to each infinitesimal area determines the type of stress. “Tensile stress” refers to the stress acting perpendicular away from the infinitesimal area. “Compressive stress” refers to the stress acting perpendicular and into the infinitesimal area. “Shear stress” refers to the stress acting parallel to the infinitesimal area. Tensile stress in a negative direction is compressive stress. “Normal stress” refers to both tensile stress and compressive stress, for example a member may carry tensile stress or compressive stress depending on external loads. In this case the member carries normal stresses.

“Pitch” within this disclosure refers to an axis of rotation which is generally perpendicular to the vertical direction and the direction of travel. Pitch angle describes a front up or a front down orientation of a component.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

Generally, the present disclosure pertains to devices and methods for a skateboard truck. A skateboard truck is used to support a skateboard on which an operator is positioned.

Disclosed is a skateboard truck having a pivot device and a hanger rotationally supported by the pivot device. The pivot device includes a bushing, bushing housing, and a pivot member. The bushing may be positioned such that the pivot member is external to the bushing periphery. The bushing housing may include a contact surface and a pivot hole. The bushing periphery may be in contact with the contact surface on the bushing housing. The pivot member may be supported in a pivot hole of the bushing housing. The hanger may be supported by the pivot member such that the hanger may tilt. The hanger may also be supported such that it can translate into and away from the pivot member.

Also disclosed is a skateboard truck that is configurable for tilting and translating in a variety of directions. This allows the operator to adjust these characteristics as desired. Additionally, means of preloading the device such that support is provided in tilt and vertical translation.

### EXAMPLES

### I: Compliant Tilting Truck

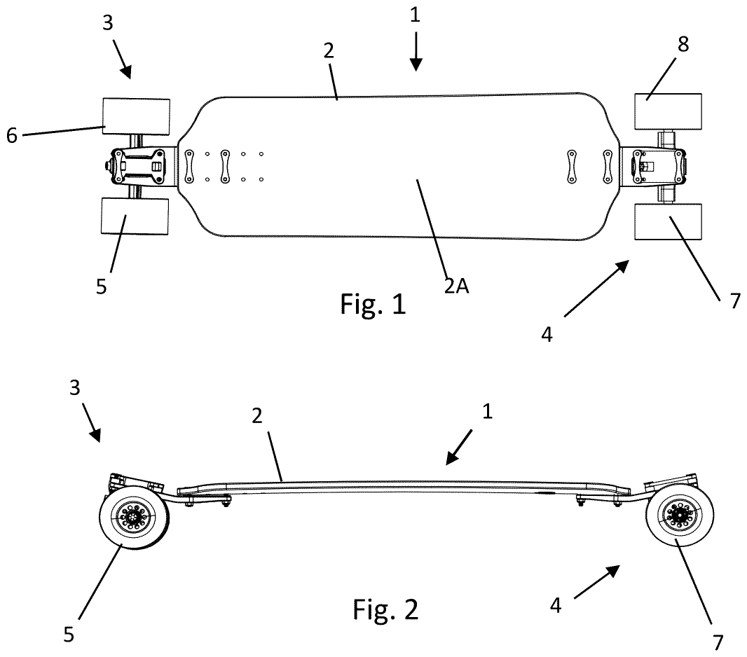

FIG. 1 depicts a skateboard 1 which includes board 2, tilting truck 3, conventional truck 4. During operation the skateboard 1 supports a user on the top surface 2A and the skateboard 1 is supported by wheels 5, 6, 7, and 8. Wheels 5, and 6 are attached to tilting truck 3, and wheels 7 and 8 are attached to conventional truck 4. Conventional truck 4 connects to board 2 on one end and tilting truck 3 connects to board 2 on the other end. In some examples, the tilting truck 3 may be attached at both ends.

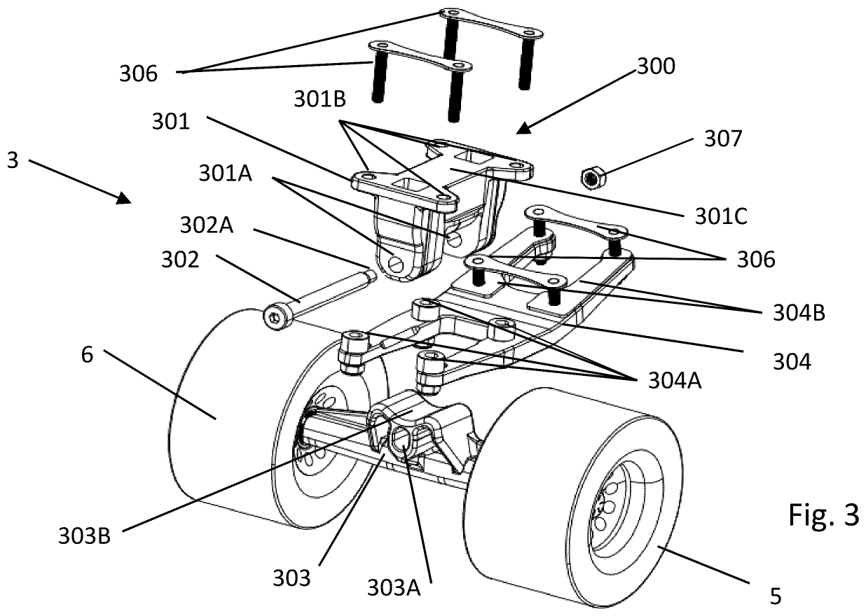

FIG. 3 depicts a tilting truck 3. Truck mount 304 supports the pivot device 300 and attaches to pivot device 300 at surfaces 304A. Truck mount 304 attaches to board 2 at surfaces 304B. In this example mounting hardware 306 attaches pivot device 300 to truck mount 304 and truck mount 304 to board 2. In some embodiments, pivot device 300 may mount directly to board 2 on board mount surface 301C. Hanger 303 rotationally supports wheels 5 and 6 and is supported by pivot device 300 by pivot member 302. Pivot device 300 provides both translation and tilt compliance.

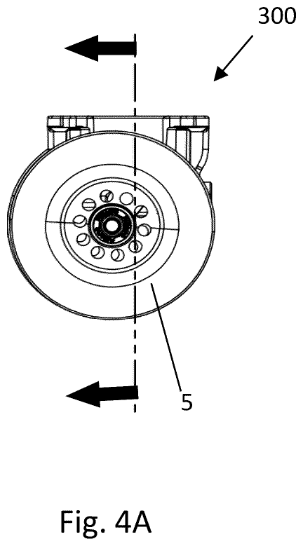

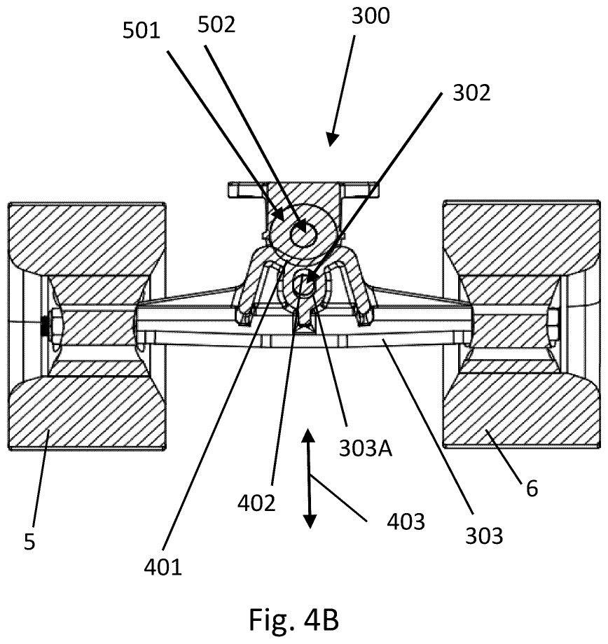

FIG. 4A depicts pivot device 300, hanger 303 rotationally supporting wheels 5 and 6. FIG. 4B depicts the cross section indicated in FIG. 4A. Further pivot device 300 is depicted providing translation compliance of hanger 303 in the direction of arrow 403. Hanger 303 includes a hanger hole 303A through which pivot member 302 is inserted. A translation space 402 is created between the pivot member 302 and hanger hole 303A. This results in bushing 501 being compressed and forming translation compression volume 701. Allowing translation gives the operator a smoother ride as obstructions are received at wheels 5 and 6. The pivot device 300 also provides tilt compliance.

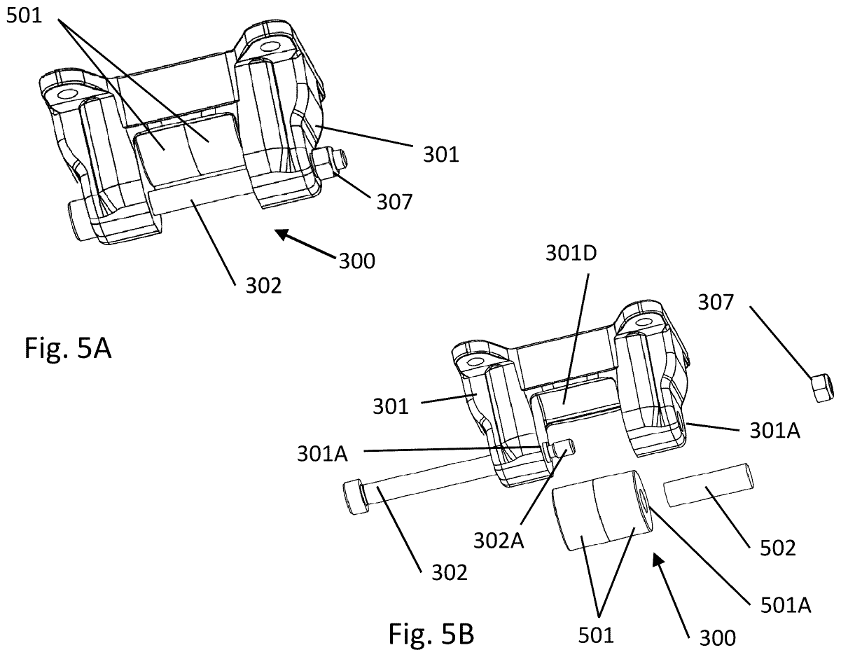

FIGS. 5A and 5B depict pivot device 300. FIG. 5B is an expanded isometric view for clarity and FIG. 5A depicts an isometric view. Bushing housing 301 includes housing contact surface 301D on which bushings 501 are supported. Bushings 501 may be of any material such as metal, plastic, or urethane. Urethanes of various durometers have been found to be useful when matching an operator with a specific pivot device 300. Bushings 501 may receive stiffener 502 that may be inserted in a hole 501A in bushings 501. In some embodiments hole 501A and stiffener 502 may be eliminated or just the stiffener may be eliminated. In this example, two bushings 501 are used; however, a single or any number of bushings 501 may be used. Also, in this example a single stiffener 502 is used; however multiple stiffeners 502 may also be used and may or may not span the length of any given bushing 501. Pivot member 302 is inserted into housing holes 301A (best shown in FIG. 3). In this example pivot member 302 includes a threaded end 302A which receives nut 307. In some examples pivot member 302 may be cylindrical. Bushings 501 are positioned such that pivot member 302 is external to the bushings 501 periphery, this positioning provides tilting resistance for hanger 303.

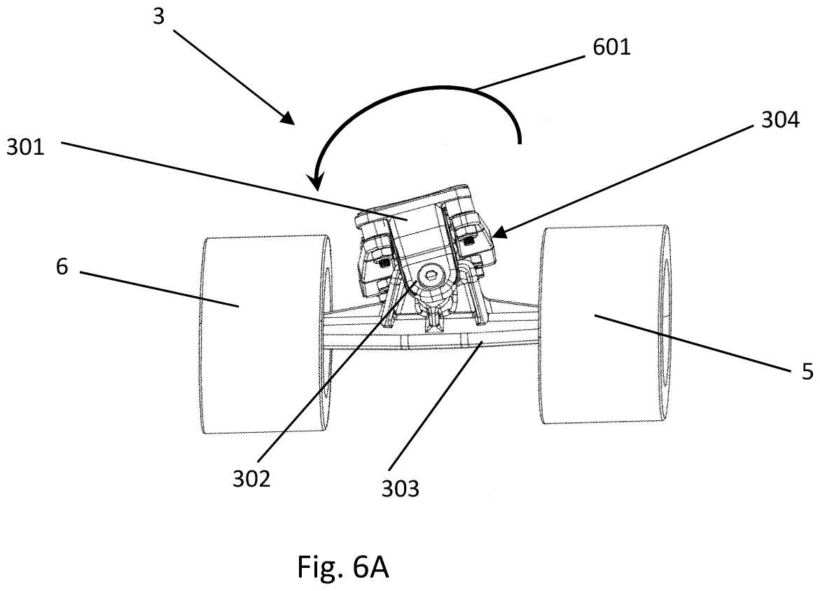

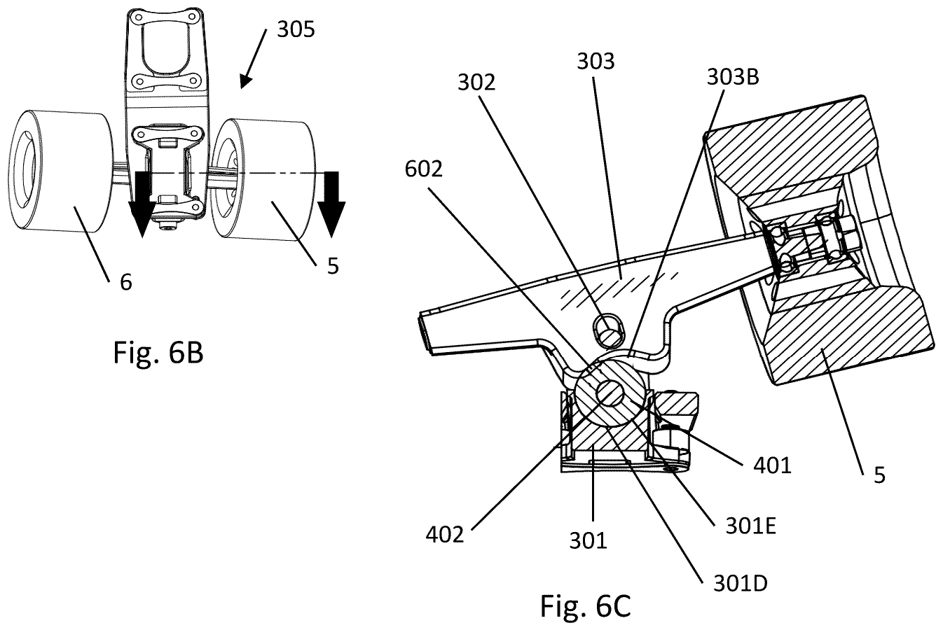

FIG. 6A shows skateboard truck 3 in a tilted configuration. In operation an operator tilts board 2 causing bushing housing 301 to tilt in direction indicated by arrow 601. FIGS. 6B and 6C depict hanger 303 rotating about pivot member 302. Compression volume 602 is established between hanger contact surface 303B and bushing 401. Additionally, compression volume 301E is established between bushing housing contact surface 301D and bushing 401. Compression volumes 602 and 301E cause a restoring torque on hanger 303 and board 2. It has been found that compression volumes 602 and 301E of this geometry cause either a linear or nonlinear increase in restoring torque with increased board 2 tilt.

The geometry in this example causes linear or nonlinear torque increases by displacing larger compression volumes 602 and 301E. As the compression volumes 602 and 301E increase in size, bushing 401 can withstand more force. With increased force the torque increases. Additional compression can be applied during assembly of pivot device 305.

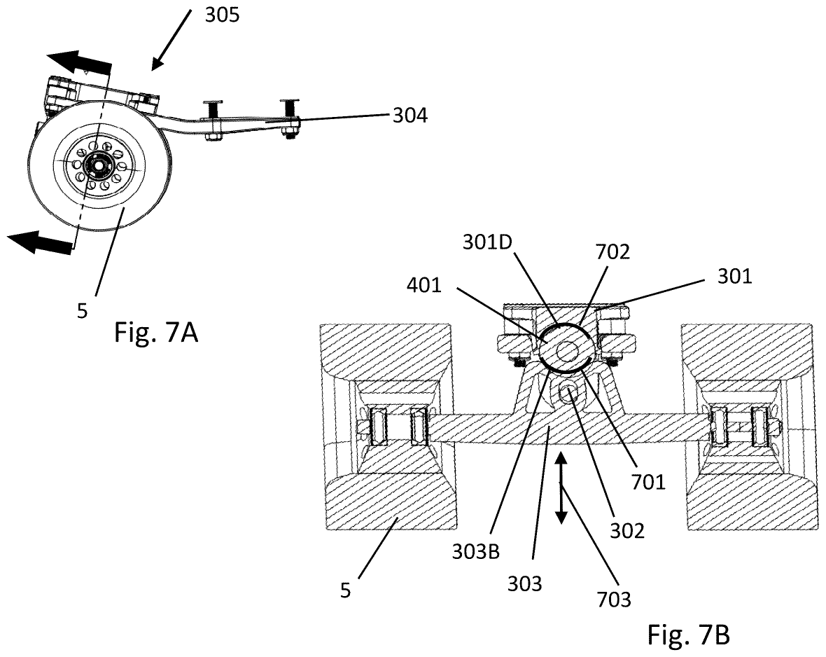

In some examples, pivot device 305 may be assembled in such a way as to initially compress bushing 401. FIGS. 7A and 7B depict bushing 401 compressed during assembly. FIG. 7A shows the location of the section cut for generating FIG. 7B. In this example, bushing 401 is configured to compress once assembled into bushing housing 301; compressed volumes 701 and 702 are created. Compressed volumes 701 and 702 cause bushing 401 to establish a preload force between hanger 303 and housing bushing 301 in direction depicted by arrow 703.

The preload force must be overcome by a vertical force on board 2 prior to deflecting bushing 401 further. The amount of preload force is determined by bushing material and the diameter. This may provide an operator with solid vertical support during use.

### II: Compliant Tilting Truck With Pitch Adjustment

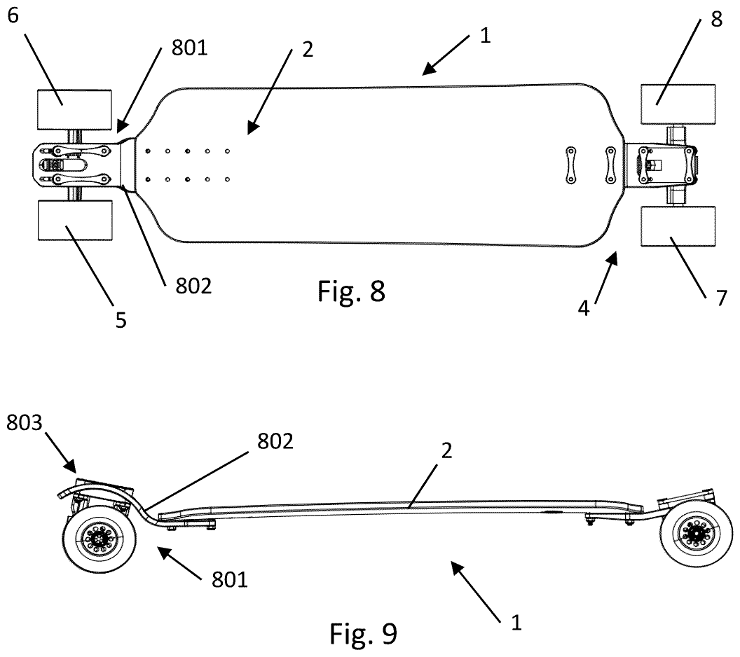

FIGS. 8 and 9 depict skateboard 1 having a tilting truck 801 with a pitch adjustment. In this example, board 2 has tilting truck 801 attached to one end of board 2 and a conventional truck 4 attached to the over end. Wheels 5 and 6 support tilting truck 801 while wheels 7 and 8 support conventional truck 4. Tilting truck 801 includes features for adjusting the pitch configuration of pivot device 803 in direction of arrow 1004. Adjusting the pitch configuration of pivot device 803 allows the operator to increase or decrease the amount of turning that tilting will allow.

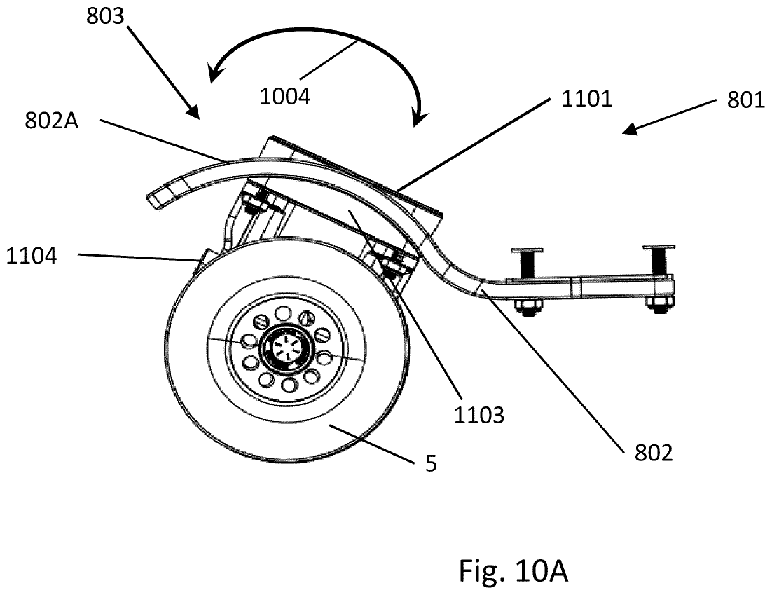

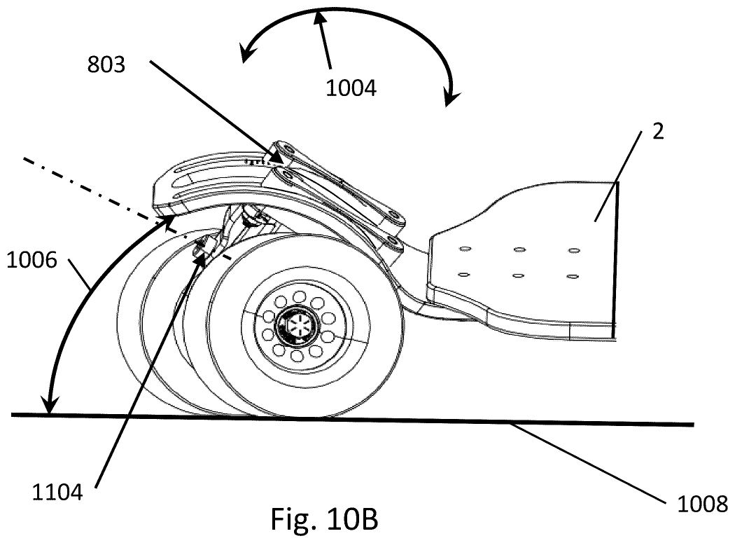

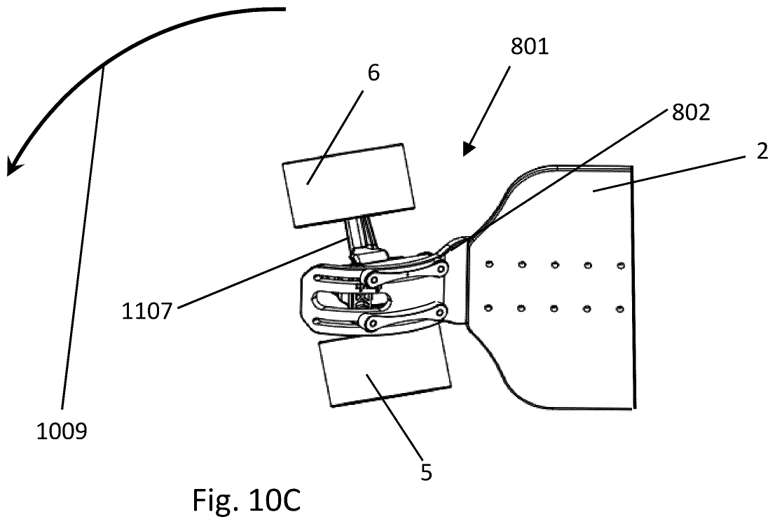

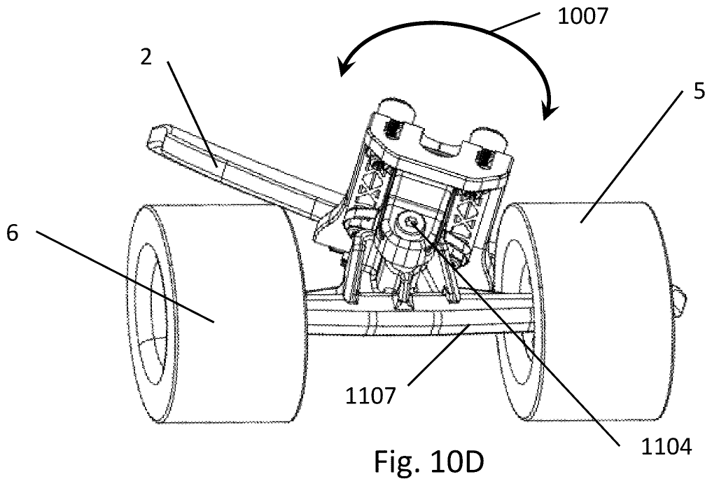

FIGS. 10A, 10B, 10C, and 10D depict tilting truck 801. In this example, truck mount 802 includes curved surface 802A which allows pivot device 803 to be adjusted in an arc depicted by arrow 1004. Arrow 1004 indicates pitch movement.

FIG. 10A depicts pitching and tilting of truck 801. Rotating and clamping pivot device 803 in the direction of arrow 1004 the pivot member 1104 is also rotated. This rotation of pivot member 1104 causes hanger 1107 to turn wheels 5 and 6 causing the skateboard to change direction.

FIGS. 10B, 10C, and 10D depict truck 801 in a tilted and pitched configuration. The current embodiment shows a relatively low tilt axis angle, while higher angles are easily imagined. Pivot device 803 is oriented in the direction of arrow 1004 such that pivot member 1104 is oriented at angle indicated by arrow 1006 from the ground 1005.

FIG. 10C depicts pivot device 803 in a pitch configuration at the angle indicated by arrow 1006. Board 2 tilted in direction indicated by 1007 (shown in FIG. 10D) may cause pivot device 803 to tilt. The combination of pitch configuration of pivot device 803 and board 2 tilting causes hanger 1107 to turn in the direction indicated by arrow 1009. Wheels 5 and 6 rotationally attached to hanger 1107, turn with hanger 1107. Wheels 5 and 6 cause the skateboard 1 to turn.

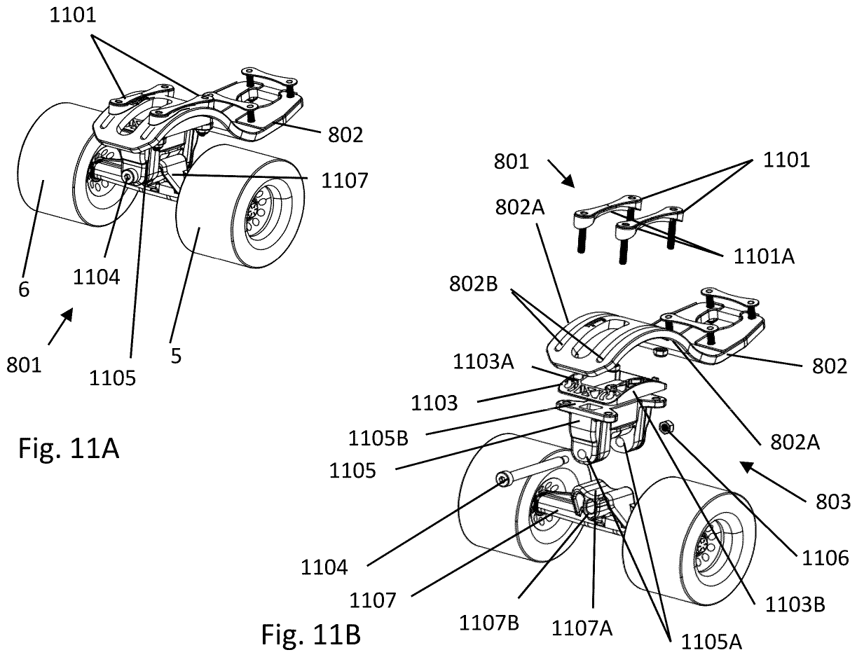

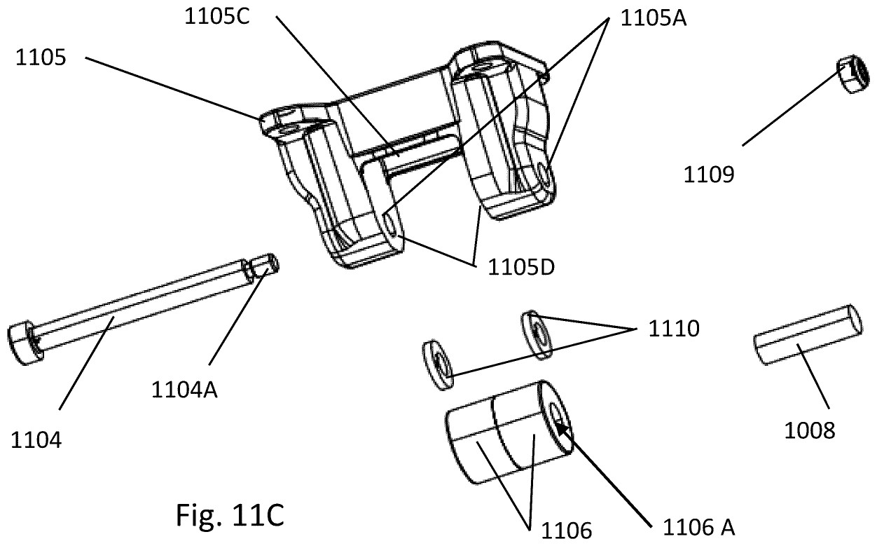

FIG. 11A depicts pitch truck 801 assembled to truck mount 802. FIG. 11B depicts an expanded view of pitch truck 801. Truck mount 802 attaches to pivot device 803 with arced housing feature 1103 located between bushing housing 1105 and truck mount 802. In order to provide good contact between bushing housing 1105 and truck mount 802 a series of surfaces may be used.

Pivot device 803 may include arced housing feature 1103 which may include an arced surface 1103A. Arced surface 1103A may support truck mount arced surface 802A. Arced housing feature 1103 may include housing mounting surface 1103B supporting bushing housing surface 1005B. Truck mount 802 may include slots 802B through truck mount 802. Pivot device 803 may include clamps 1101 which may be used to clamp truck mount 802 to bushing housing 1105. In this example, curved clamps 1101 include curved surfaces 1101A which may provide secure attachment of truck mount 802 to pivot device 803. Pivot device 803 supports the hanger 1107. The pitch configuration of truck 801 is adjusted by sliding pivot device 803 along arced surface 802A. The pitch configuration of truck 801 is held in place by clamping truck mount 802 between arced housing feature 1103 and curved clamps 1101. In some embodiments arced surface 1103A and curved surfaces 1101A provide secure mounting of pivot device 801 to truck mount 802.

FIG. 11C depicts a portion of pivot device 803. Bushing housing 1105 includes housing contact surface 1105C on which bushings 1106 are supported. Bushings 1106 may include a stiffener 1108 that may be inserted in hole 1106A in bushings 1106. In some examples, hole 1106A and stiffener 1108 may be eliminated or just the stiffener 1108 may be eliminated. In this example, two bushings 1106 are used; however, a single or multiple bushings 1106 may be used. Bushings 1106 may be of any material such as metal, plastic, or urethane. Urethanes of various durometers have been found to be useful when matching an operator with a specific pivot device 803. Also, in this example a single stiffener 1108 is used; however multiple stiffeners 1108 may also be used and may or may not span the length of any given bushing 1106. Pivot member 1104 is inserted into housing holes 1105A. In some embodiments, thrust washers 1110 are included and may rest against bushing housing wall 1105D and bushing 1106. Thrust washer 1110 may carry a load parallel to the long axis of pivot member 1104 as tilting device 803 is pitch adjusted indicated by arrow 1004. Thrust washers 1110 may be a thrust bearing or bearings as well as a radial bearing or bearings able to carry a thrust load. In this example pivot member 1104 includes a threaded end 1104A which receives nut 1109. In some examples, pivot member 1104 is cylindrical. Bushings 1106 are positioned such that pivot member 1104 is external to the periphery of the bushings 1106 this positioning provides pivoting resistance for hanger 1107.

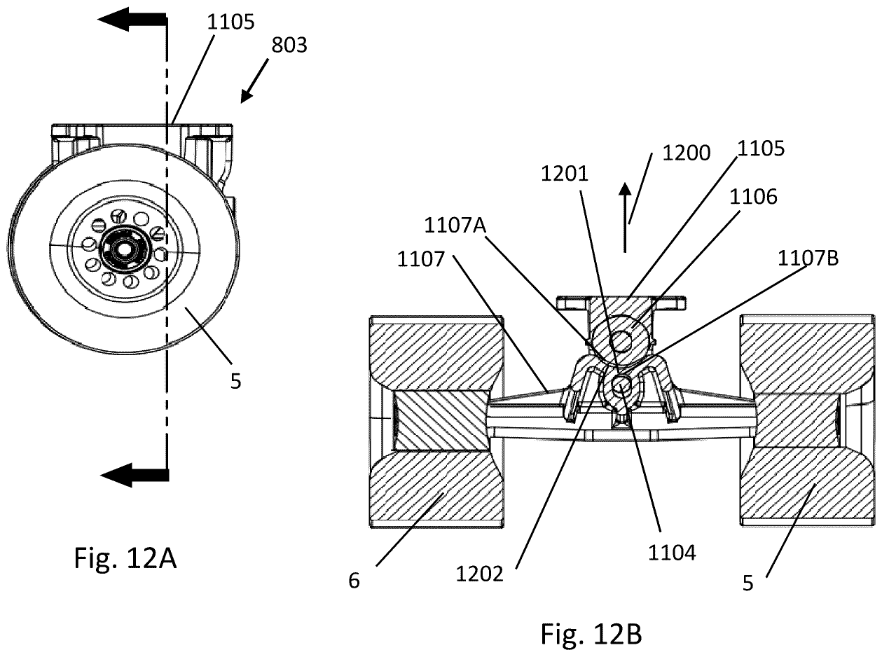

FIG. 12A depicts pivot device 803, hanger 1107 rotationally supporting wheels 5 and 6 and shows the location of the section cut for generating FIG. 12B. FIG. 12B depicts the cross section indicated in FIG. 12A. Further pivot device 803 is depicted providing translation compliance of hanger 1107 in the direction of arrow 1200. Hanger 1107 includes a hanger hole 1107B through which pivot member 1104 is inserted. A translation space 1201 is created between the pivot member 1104 and hanger hole 1107B. This results in bushing 1106 being compressed and forming translation compression volume 1202. Allowing translation gives the operator a smoother ride as obstructions are received at wheels 5 and 6. The pivot device 801 also provides tilt compliance.

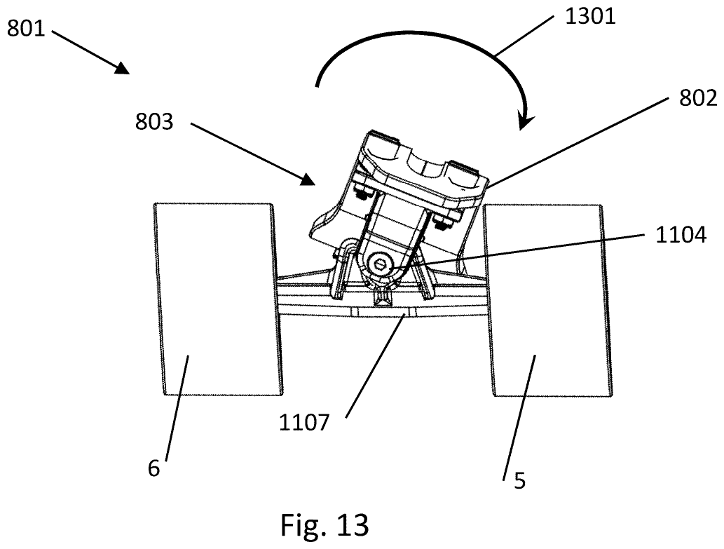

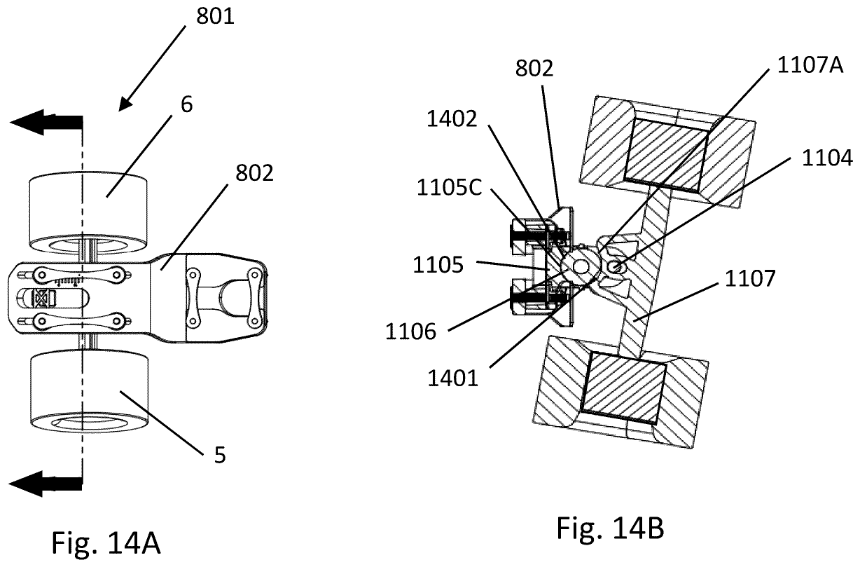

FIG. 13 depicts skateboard truck 801 in a tilted configuration. In operation an operator tilts board 2 causing pivot device 803 to tilt in direction indicated by arrow 1301. FIG. 14A depicts skateboard truck 801 in a tilted configuration. FIG. 14B depicts a section view indicated in FIG. 14A. Truck 801 in a tilted configuration causes hanger 1107 to rotate about pivot member 1104. Compression volume 1401 is established between hanger contact surface 1107A and bushing 1106. Additionally, compression volume 1402 is established between bushing housing contact surface 1105C and bushing 1106. Compression volumes 1402 and 1401 cause a restoring torque on hanger 1107 and board 2. It has been found that compression volumes of this geometry cause a nonlinear increase in restoring torque with increased board 2 tilt.

The geometry in this example causes nonlinear torque increases by displacing compression volumes 1402 and 1401. As the compression volumes 1402 and 1401 increase in size the bushing 1106 can withstand more force. With increased force the torque increases. Additionally, preload may be applied during assembly of pivot device 803.

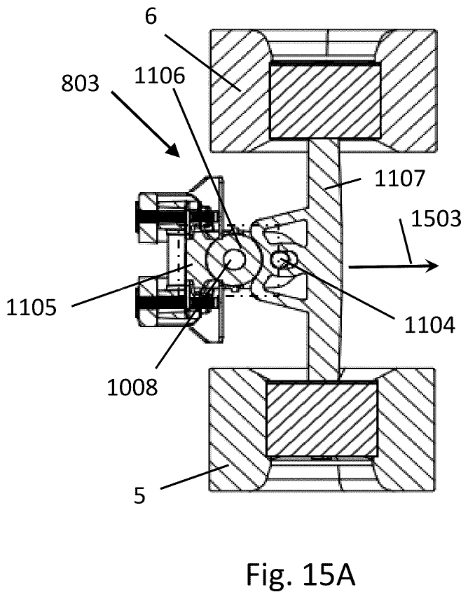

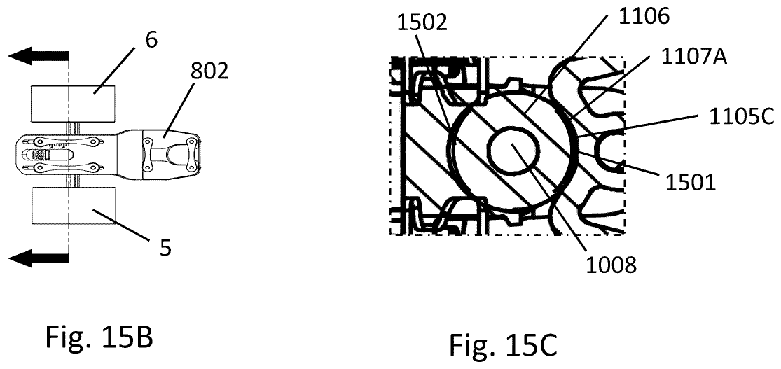

In some examples pivot device 803 may be assembled in such a way as to initially compress bushing 1106. FIGS. 15A, 15B, and 15C depict bushing 1106 compressed during assembly. FIG. 15A shows the location of the section cut for generating FIG. 15B. FIG. 15C is a detail indicated in FIG. 15B. In this example, bushing 1106 is configured to compress once assembled into bushing housing 1105; compressed volumes 1502 and 1501 are created. Compressed volumes 1502 and 1501 cause bushing 1106 to establish a preload force between hanger 1107 and bushing housing 1105 in direction depicted by arrow 1503. Preload force between hanger 1107 and bushing housing 1105 provides extra vertical support of board 2.

Preload force must be overcome by a vertical force on board 2 prior to deflecting bushing 1106 further. The amount of preload force is determined by the bushing material and the amount of initial compression. This may provide an operator with solid vertical support during use.

### III: Compliant Tilting Truck With Fixed Pitch

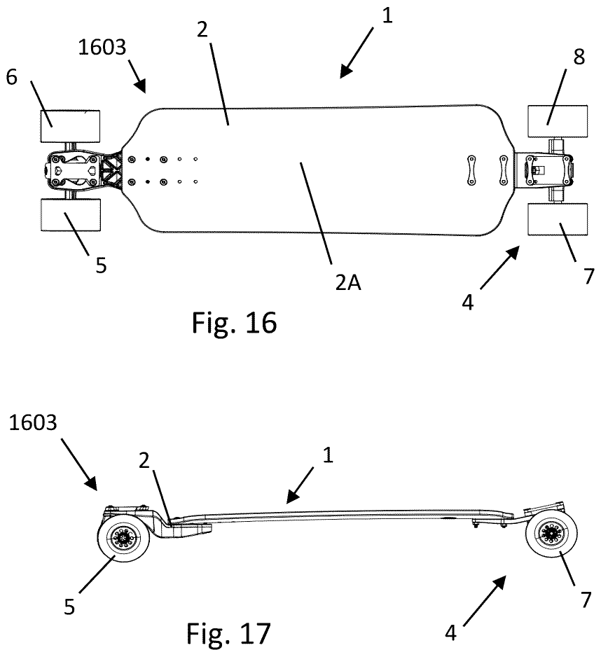

FIGS. 16 and 17 depict skateboard 1 which includes board 2, tilting truck 1603, and conventional truck 4. During operation the skateboard 1 supports an operator on the top surface 2A and the skateboard 1 is supported by wheels 5, 6, 7, and 8. Wheels 5, and 6 are attached to tilting truck 1603, and wheels 7 and 8 are attached to conventional truck 4. Conventional truck 4 connects to board 2 on one end and tilting truck 1603 connects to board 2 on the other end. In some examples, the tilting truck 1603 may be attached on both ends.

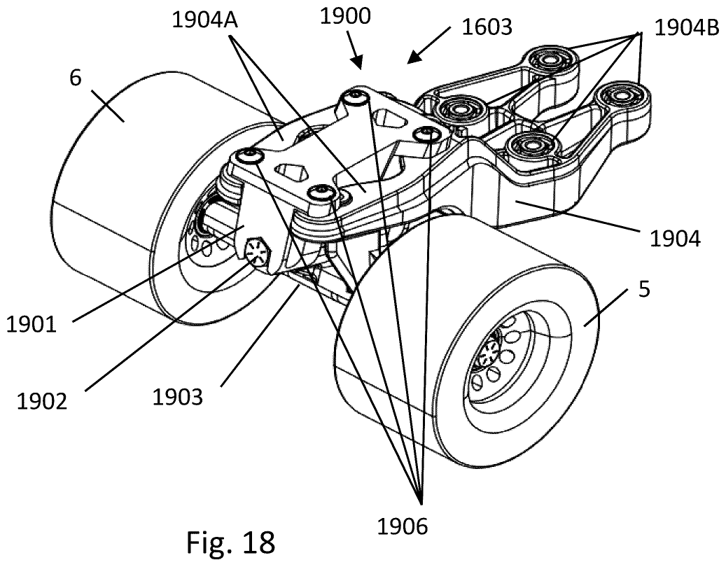

FIG. 18 depicts a tilting truck 1603. Truck mount 1904 supports the pivot device 1900 and attaches to pivot device 1900 at surfaces 1904A. Truck mount 1904 attaches to board 2 at surfaces 1904B. In this example mounting hardware 1906 attaches pivot device 1900 to truck mount 1904 and truck mount 1904 to board 2. Hanger 1903 rotationally supports wheels 5 and 6 and is supported by pivot device 1900 by pivot member 1902.

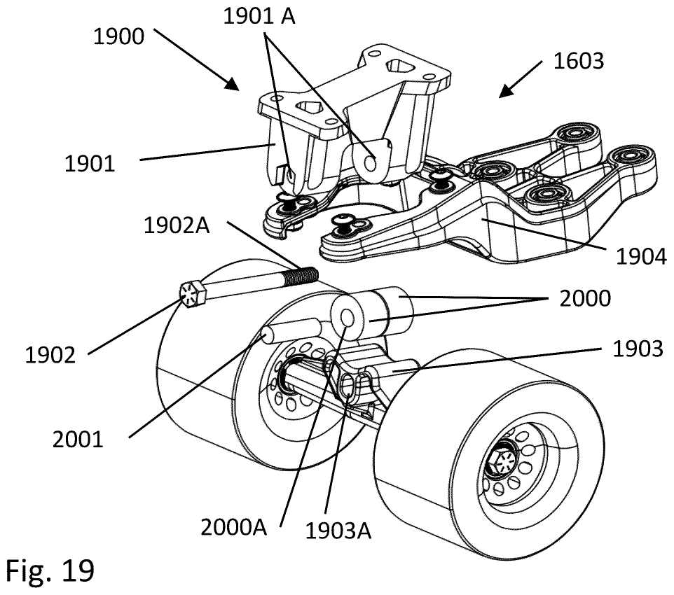

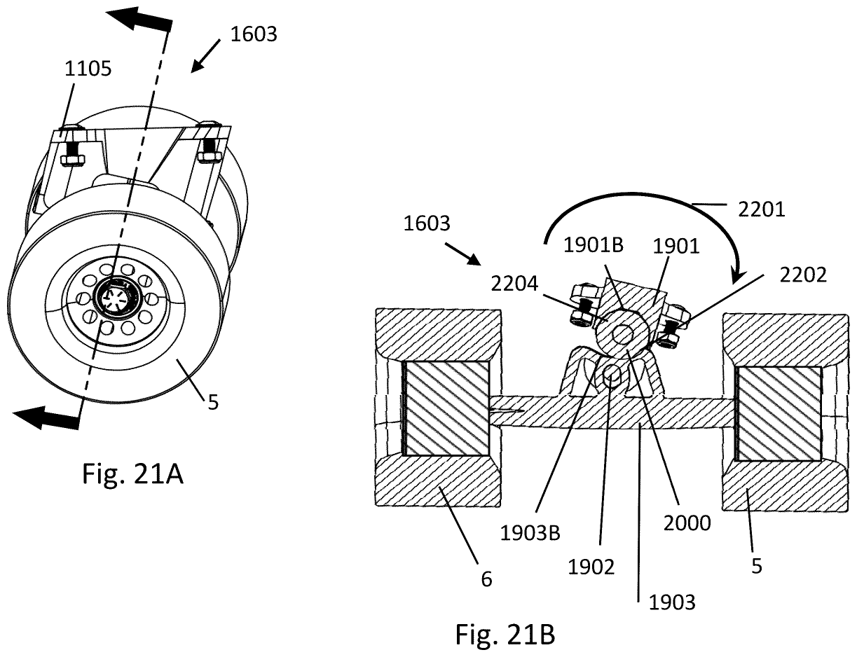

FIGS. 18 and 19 depict tilting truck 1603 as an expanded isometric. Bushing housing 1901 includes housing contact surface 1901D (best depicted in FIG. 21B) on which bushing 2000 are supported. Bushings 2000 may receive stiffener 2001 that may be inserted in a hole 2000A in bushings 2000. In some examples, hole 2000A and stiffener 2001 may be eliminated or just the stiffener 2001 may be eliminated. In this example, two bushings 2000 are used; however, a single or multiple bushings 2000 may be used. Also, in this example a single stiffener 2001 is used; however multiple stiffeners 2001 may also be used and may or may not span the length of any given bushing 2000. Pivot member 1902 is inserted into housing holes 1901A (best shown in FIG. 19). In this example housing holes 1901A are angled relative to surfaces 1904A. Preferably pivot member 1902 is supported on both ends by housing holes 1901A, this provides better support than using one housing hole 1901A. Angled housing holes 1901A fix a pivot member 1902 for a specific amount of pitch which results in a fixed amount of turning during tilt of board 2.

In this example pivot member 1902 includes a threaded end 1902A which receives a nut (not shown) for attaching pivot member 1902 to housing 1901. Pivot member 1902 may be inserted into hanger 1903 at hanger hole 1903A. Bushings 2000 are positioned such that pivot member 1902 is external to the periphery of bushings 2000; this positioning provides pivoting resistance for hanger 1903. Pivot device 1900 may also provide both translation and tilt compliance.

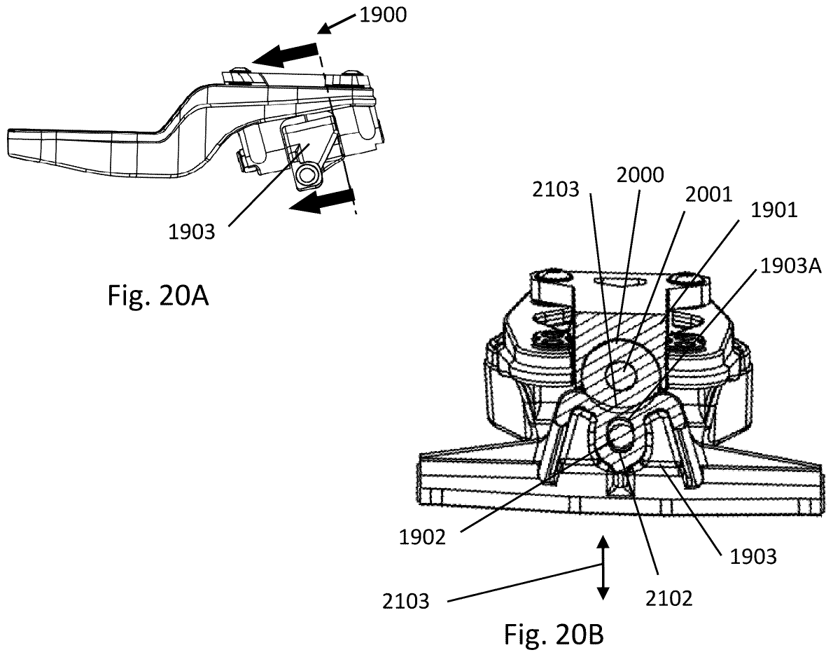

FIG. 20A depicts pivot device 1900, and hanger 1903 rotationally supporting wheels 5 and 6 not shown. FIG. 20B depicts the cross section indicated in FIG. 20A. Further pivot device 1900 is depicted providing translation compliance of hanger 1903 in the direction of arrow 2103. Hanger 1903 includes a hanger hole 1903A through which pivot member 1902 is inserted. A translation space 2102 is created between the pivot member 1902 and hanger hole 1903A. This results in bushing 2000 being compressed and forming translation compression volume 2103. Allowing translation gives the operator a smoother ride as obstructions are received at wheels 5 and 6. The pivot device 1903 also provides tilt compliance.

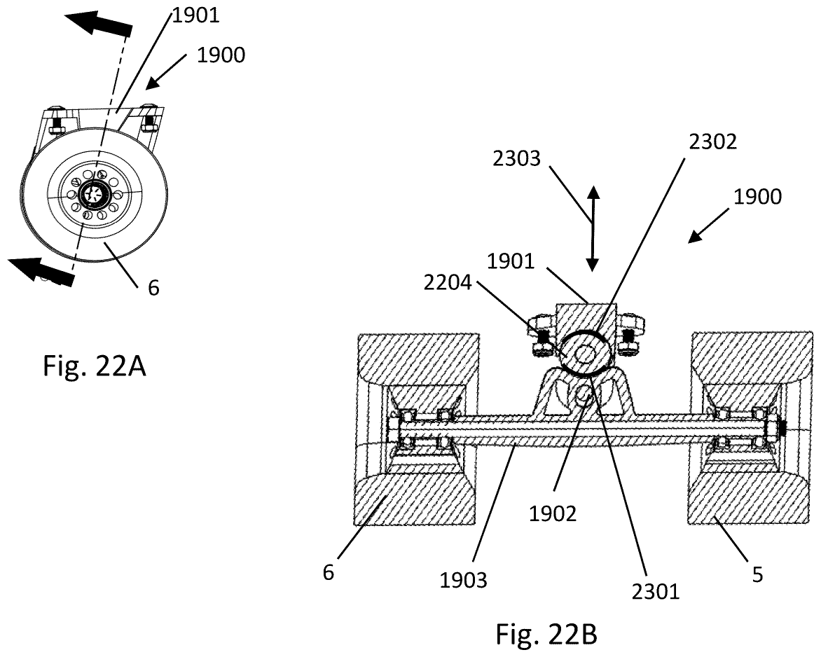

FIGS. 21A and 21B depict tilting truck 1603. In operation an operator tilts board 2 causing bushing housing 1901 to tilt in direction indicated by arrow 2201. FIGS. 22A and 22B locate and depict hanger 1903 rotating about pivot member 1902. Compression volume 2202 is established between hanger contact surface 1903B and bushing 2000. Additionally, compression volume 2204 is established between bushing housing contact surface 1901B and bushing 2000. Compression volumes 2204 and 2202 cause a restoring torque on hanger 1903 and board 2. It has been found that compression volumes of this geometry cause a nonlinear increase in restoring torque with increased board 2 tilt.

The geometry in this example causes nonlinear torque increases by displacing larger compressions volumes 2204 and 2202. As the compression volumes 2204 and 2202 increase in size the bushing can withstand more force. With increased force the torque increases. Additionally, preload can be applied during assembly of pivot device 1603.

In some examples pivot device 1900 may be assembled in such a way as to initially compress bushing 2204. FIGS. 22A and 22B depict bushing 2204 compressed during assembly. FIG. 22A shows the location of the section cut for generating FIG. 22B. In this example, bushing 2204 may be configured to compress during assembly into bushing housing 1901; compressed volumes 2301 and 2302 are created. Compressed volumes 2301 and 2302 cause bushing 2204 to establish a preload force between hanger 1903 and housing bushing 1901 in direction depicted by arrow 2303.

Preload force must be overcome by a vertical force on board 2 prior to deflecting bushing 2204 further. The amount of preload force is determined by the bushing material and the amount of initial compression. This may provide an operator with solid vertical support during use.

### IV. Compliant Tilting Truck With Bushing Support

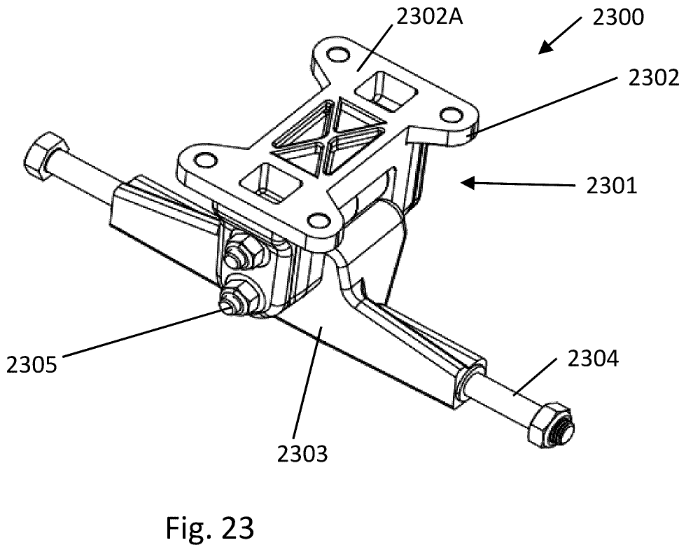

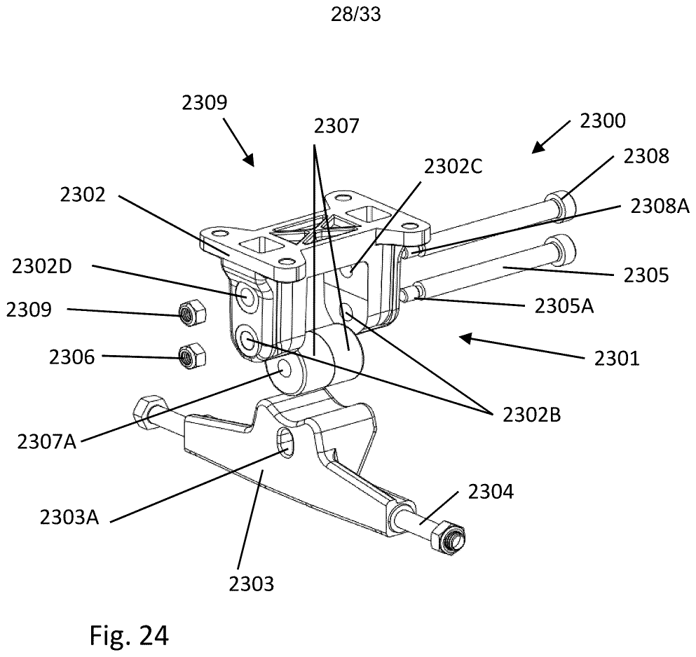

FIGS. 23 and 24 depict compliant truck 2300 without wheels and truck mount. Pivot device 2301 may attach to a truck mount at truck mount surface 2302A of bushing housing 2302. Hanger 2303 rotationally supports wheels not shown on axle 2304 and is supported by pivot device 2301 by pivot member 2305. Bushing housing 2302 may support pivot member 2305 inside housing holes 2302B. In some embodiments, pivot member 2305 includes a pivot member threaded end 2305A which may thread into nut 2306. In this example, pivot member 2305 is retained by threading into nut 2306, but any means of retaining pivot member 2305 to bushing housing 2302 is sufficient. Hanger 2303 is supported by pivot device 2301 by pivot member 2305 and hanger hole 2303A.

Bushings 2307 are supported in bushing housing 2302 by bushing support 2308 and housing holes 2302C and 2302D located on bushing housing 2302. During assembly, bushing support 2308 is inserted through housing hole 2302C, through bushings holes 2307A, through remaining housing hole 2302D, and nut 2309 is threaded onto bushing support 2308 at threaded end 2308A. Bushing support 2308 may include threaded end 2308A which threads onto nut 2309 and retains bushing support 2308 to bushing housing 2302. In some examples, bushing support 2308 may be retained to bushing housing 2302 by other means including but not limited to a hole and pin, a retaining ring and groove, or a press fit between housing hole 2307C or 2307D, and bushing support 2308. Pivot device 2301 provides both translation and tilt compliance.

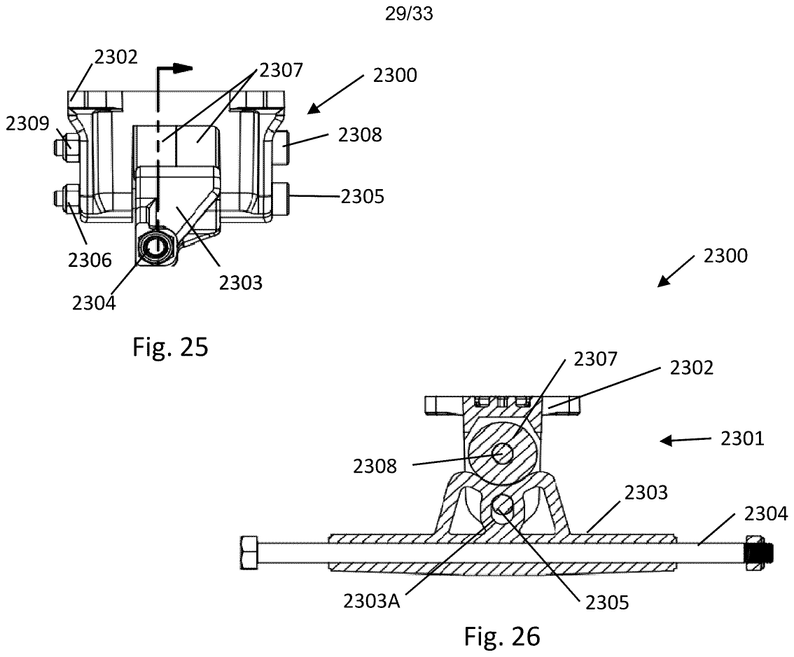

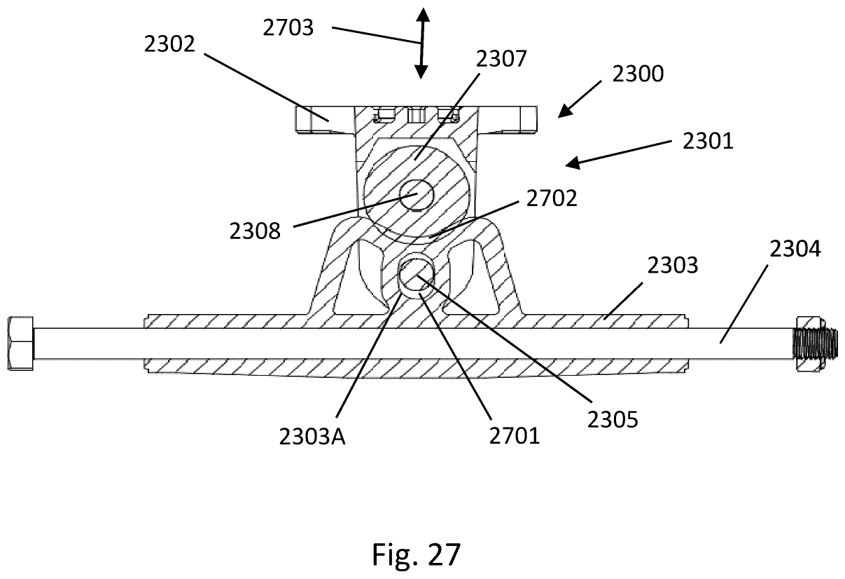

FIG. 27 depicts the cross section indicated in FIG. 25 of compliant truck 2300 without wheels and truck mount. Hanger 2303 is compliantly translated in the direction indicated by arrow 2703. Hanger 2303 includes a hanger hole 2303A through which pivot member 2305 is inserted. A translation space 2701 is created between the pivot member 2305 and hanger hole 2303A. This results in bushing 2307 being compressed and forming translation compression volume 2702. Allowing translation gives the operator a smoother ride as obstructions are received at wheels 5 and 6 (not shown). With bushing support 2308 fixed to bushing housing 2302, pivot device 2300 is retained during extreme compliance use. The pivot device 2300 also provides tilt compliance.

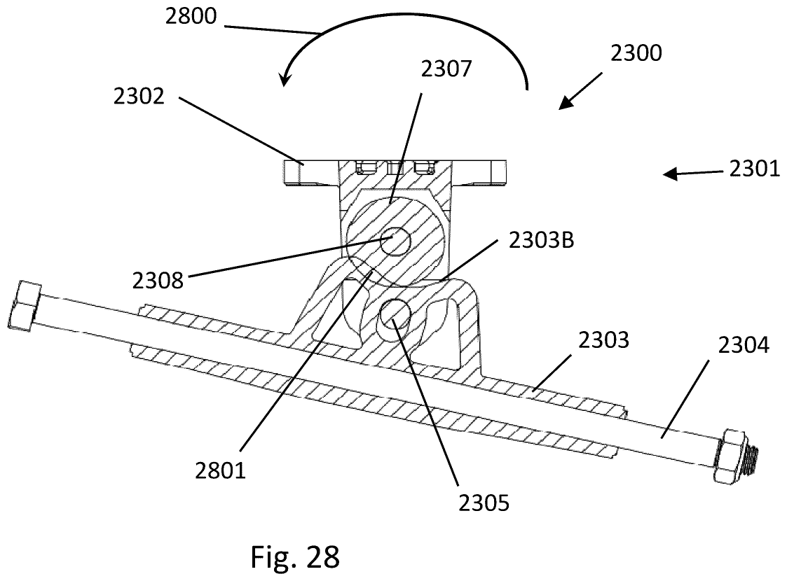

FIG. 28 depicts a cross section indicated in FIG. 25 of compliant truck 2300 without wheels and truck mount. Bushing housing 2302 is tilted as indicated by arrow 2800. An operator tilts board 2 causing bushing housing 2302 to tilt in direction indicated by arrow 2800. Compression volume 2801 is established between hanger contact surface 2303B and bushing 2307. Compression volume 2801 causes a restoring torque on hanger 2303. It has been found that compression volume 2801 of this geometry causes either a linear or nonlinear increase in restoring torque with increased tilt.

The geometry in this example causes linear or nonlinear torque increases by displacing a larger compression volume 2801. As the compression volume 2801 increases in size bushing, 2307 can withstand more force. With increased force the torque increases. Additional compression can be applied during assembly of pivot device 2301.

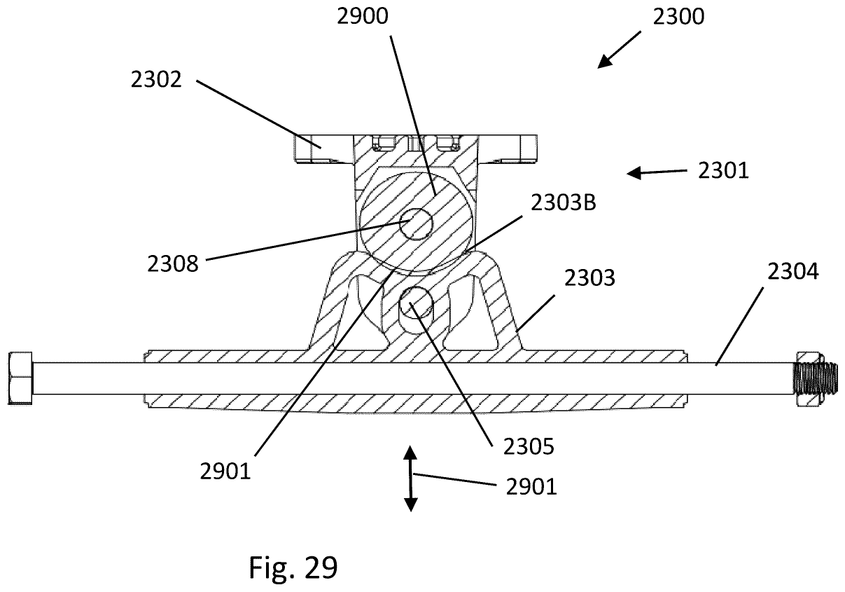

FIG. 29 depicts a cross section indicated in FIG. 25 of compliant truck 2300 without wheels and truck mount. In some examples pivot device 2301 may be assembled with a preload on bushing 2900. In this example, bushing 2900 is configured to compress once assembled into hanger surface 2303B; compressed volume 2901 is created. Compressed volume 2901 causes bushing 2900 to establish a preload force between hanger 2303 and housing bushing 2302 in the direction depicted by arrow 2901.

The preload force must be overcome by a vertical force on board 2 prior to deflecting bushing 2900 further. The amount of preload force may determine by bushing material and the size of compressed volume 2901. This may provide an operator with solid vertical support during use.

### IV: Additional Bushing Geometries

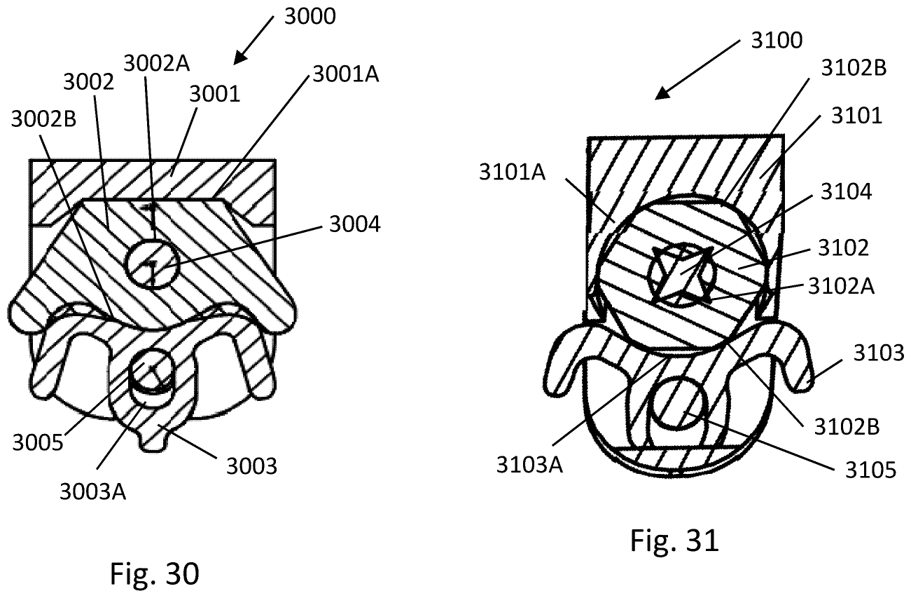

FIGS. 30 and 31 depict cross sections of pivot devices 3000 and 3100. FIG. 30 depicts bushing 3002 which is shaped as a bell. Bushing 3002 may include a hole 3002A configured to receive stiffener 3004. Bushing housing 3001 supports bushing 3002 at surface 3001A and bushing 3002 supports hanger 3003 at surface 3002B. Hanger 3003 is retained by pivot member 3005 which is inserted into hanger hole 3003A. Hole 3002A and stiffener 3004 may be used but are not required in all embodiments. Hole 3002A and stiffener 3004 may be round as shown but this is not a requirement. Hole 3002 may be conical, rectangular, triangular, or any other geometry as well as open to any external surface of bushing 3002. As well, the geometry of bushing 3002 may be conical, rectangular, triangular, or any other geometry. Stiffener 3004 need not be included in some embodiments.

FIG. 31 depicts bushing 3102 which is hexagonal and includes a star shaped hole 3102A. Bushing 3102 supports bushing housing 3101 on surface 3101A at bushing corner radii 3102B. Bushing 3102 also supports hanger 3103 on surface 3103A at bushing corner radii 3102B. Pivot member 3105 retains housing 3103. Bushing 3102 may include hole 3102A. Hole 3102A may be star-shaped and stiffener 3104 may be inserted into hole 3102A. Hole 3102A may be conical, rectangular, triangular, or any other geometry as well as open to any external surface of bushing 3102. As well, the geometry of bushing 3102 may be conical, rectangular, triangular, or any other geometry. Stiffener 3104 need not be included in some embodiments.

Any bushing, hanger, and housing geometry may be used including but not limited to conical, rectangular, spherical, and triangular. Any shape of bushing 3002, bushing housing surface 3001A, and hanger surface 3002B may be used. Indeed, any material body with a complete periphery may be used as a bushing without deviating from the embodiment of the disclosure. As well any bushing housing surface 3001A and hanger surface 3002B may have any geometry with or without consideration of the bushing geometry.

### Advantages, Features, and Benefits

The examples of the skateboard truck described herein provide several advantages over known skateboard trucks. For example, illustrative examples described herein provide nonlinear force/torque response to both translation and tilt. Preloading the bushing described may be configured to solidly support the operator while still responding to active effort by the operator. Preloading provides return to an initial position or configuration which may be desired by some operators.

Additionally, the pitch of the pivot device may be adjustable by the operator. This pitch adjustment may be used to increase or decrease the amount of “turning” the truck will allow. This can be very helpful when traveling at high speeds or long distances.

Additionally, in the present pivot device the pivot member is supported at both ends. In a conventional truck the pivot member (also known as a kingpin) is supported at a single end. As the skateboard is tilted the pivot member is tilted and stressed in a cantilever fashion. The kingpin carries much higher stresses in the conventional configuration. A conventional kingpin would normally be a ⅜ inch (0.9525 cm) bolt, in comparison in the present disclosure the pivot member may be a 5/16 inch (0.79375 cm) or smaller bolt.

Additionally, in the present pivot device slop within the device is eliminated by preloading and fully supported components. A conventional truck typically supports the kingpin by an axial load only. A large clearance hole on the conventional hanger allows movement of the hanger relative to the kingpin. However, in order to increase the resistance to the hanger movement more friction is required between the conventional bushings and the conventional hanger. To increase this friction more axial force on the kingpin is required, thus increasing the stress on the kingpin.

Additionally, sliding components are eliminated. This prevents squeaking caused by sliding components in a conventional skateboard truck.

### Conclusion

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary examples were chosen and described in order to best explain the principles of the present technology and its practical application, and to enable others of ordinary skill in the art to understand the present technology for various examples with various modifications as are suited to the particular use contemplated.

In the above description, for purposes of explanation and not limitation, specific details are set forth, such as particular examples, procedures, techniques, etc. in order to provide a thorough understanding of the present disclosure. However, it will be apparent to one skilled in the art that the present disclosure may be practiced in other examples that depart from these specific details.

Reference throughout this specification to “one example” or “an example” means that a particular feature, structure, or characteristic described in connection with the examples is included in at least one example of the present disclosure. Thus, the appearances of the phrases “in one examples” or “in an examples” or “according to one example” (or other phrases having similar import) at various places throughout this specification are not necessarily all referring to the same examples. Furthermore, the particular features, structures, or characteristics may be combined in any suitable manner in one or more examples. Furthermore, depending on the context of discussion herein, a singular term may include its plural forms and a plural term may include its singular form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only, and not limitation. The descriptions are not intended to limit the scope of the invention to the particular forms set forth herein. To the contrary, the present descriptions are intended cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

I claim:

1. A skateboard truck comprising;
a pivot device, comprising,
a housing having a pivot hole and a housing contact surface,
a pivot member supported by the pivot hole,
a bushing having a periphery and positioned such that the pivot member is external to the bushing periphery, and
a hanger supported by the pivot member and having a hanger contact surface in contact with the bushing periphery.

2. The skateboard truck of claim 1, wherein the bushing includes a hole and the pivot device further includes a bushing support configured to support the bushing at the hole.

3. The skateboard truck of claim 1, wherein the hanger includes a hanger hole for rotationally supporting the pivot member.

4. The skateboard truck of claim 1, wherein the bushing includes a hole and the pivot device further includes a stiffening member supported in the bushing hole.

5. The skateboard truck of claim 4, wherein the bushing hole is round.

6. The skateboard truck of claim 4, wherein the bushing is preloaded between the hanger contact surface and the bushing support.

7. The skateboard truck of claim 1, wherein the bushing is cylindrical.

8. The skateboard truck of claim 1, wherein the pivot device further includes a thrust washer configured to support the hanger.

9. The skateboard truck of claim 1, wherein the housing contact surface is in contact with the periphery of the bushing.

10. The skateboard truck of claim 9, wherein the bushing is preloaded between the housing contact surface and the hanger contact surface.

11. The skateboard truck of claim 9, wherein the housing contact surface is configured to compress the bushing as the pivot device is tilted.

12. The skateboard truck of claim 11, wherein the housing contact surface is configured to compress the bushing such that a torque on the hanger is increased as the pivot device is tilted.

13. The skateboard truck of claim 9, wherein housing contact surface is configured to compress the bushing as the hanger translates.

14. The skateboard truck of claim 13, wherein the housing contact surface is configured to compress the bushing such that a force on the hanger is increased as the hanger translates.

15. The skateboard truck of claim 3, wherein the hanger hole is a slot configured to allow the hanger to translate.

16. The skateboard truck of claim 1, further comprising a pitch adjustment.

17. The skateboard truck of claim 16, wherein the housing includes an arced surface configured to adjust the pivot member in a pitch configuration.

18. The skateboard truck of claim 17, further comprising a truck mount having a curved surface configured to adjust the pivot member in a pitch configuration.

19. The skateboard truck of claim 1, wherein the pivot device includes an attachment surface configured to locate the pivot member in a fixed pitch configuration.

20. The skateboard truck of claim 1, wherein the pivot device includes a board mount surface configured to attach to a board.
